(19) United States
(12) Patent Application Publication
(10) Pub. No.: US 2025/0371324 A1
(43) Pub. Date: Dec. 4, 2025

(54) GENERATIVE MODEL EXPERIENCE USING OPEN PROMPT

(71) Applicant: Snap Inc., Santa Monica, CA (US)

(72) Inventors: Nathan Kenneth Boyd, Los Angeles, CA (US); Thomas Searle, Venice, CA (US); Matthew Saunders, Santa Monica, CA (US)

(21) Appl. No.: 18/679,223

(22) Filed: May 30, 2024

(51) Int. Cl. G06N 3/0475; G06T 19/00; G06V 40/16

(52) U.S. Cl. CPC G06N 3/0475; G06T 19/006; G06V 40/16; G06T 2219/2004

(57) ABSTRACT

Described is a system for a generative model XR Experience using open prompt by receiving a first prompt of a first user via a user interface of a user device indicating a user's intent, processing the first prompt using a first machine learning model to generate a second prompt that is applied to a second machine learning model, the second prompt indicative of attributes associated with the first prompt, capturing an image of the first user via a camera feed of the user device, processing a combination of the image of the first user with the second prompt using the second machine learning model to generate a plurality of images, and applying the plurality of images to the live camera feed of the user device.

### TECHNICAL FIELD

The present disclosure relates generally to generative models, in particular, to a generative model experience using open prompts.

### BACKGROUND

As the popularity of Artificial Intelligence (AI) grows, companies use machine learning models in various ways, which is transforming how we process, analyze, and interact with visual data. The use of AI in image processing involves training algorithms, particularly deep learning models like Convolutional Neural Networks (CNNs), to perform tasks that range from low-level image manipulation to high-level understanding and generation of visual content. Some prominent applications of AI in images include image classification, object detection, image segmentation, facial recognition, and style transfer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 is a flowchart illustrating an example method for generating a prompt using a first machine learning model and generating images using a second machine learning model, according to some examples.

FIG. 5 illustrates an example of the generation of multiple images from a user prompt using an LLM and generative machine learning model, according to some examples.

FIG. 6 illustrates a user interface enabling a user to input a first prompt, according to some examples.

FIG. 7 illustrates a user interface displaying a live camera feed of a user device and receiving of a user prompt, according to some examples.

FIG. 8 illustrates a user interface indicating an image captured by the user device, according to some examples.

FIG. 9 illustrates a user interface that indicates loading of the generative AI processing, according to some examples.

FIG. 10 illustrates video recording of a rotation of the generated images that were responsive to the user's prompt, according to some examples.

FIG. 11 illustrates a user interface where the generated images are still rotating from FIG. 10, according to some examples.

FIG. 12 illustrates a user interface including the user with the selected recommendation responsive to the user query, according to some examples.

FIG. 13 illustrates a user interface that includes the generated image that tracks the identity of the user, according to some examples.

FIG. 14 illustrates an architecture for refining the generative content item creation, according to some examples.

FIG. 15 is a diagrammatic representation of a message, according to some examples.

FIG. 16 illustrates a system including a head-wearable apparatus with a selector input device, according to some examples.

FIG. 17 is a diagrammatic representation of a machine in the form of a computer system within which a set of instructions may be executed to cause the machine to perform any one or more of the methodologies discussed herein, according to some examples.

FIG. 18 is a block diagram showing a software architecture within which examples may be implemented.

FIG. 19 illustrates a machine-learning pipeline, according to some examples.

FIG. 20 illustrates training and use of a machine-learning program, according to some examples.

### DETAILED DESCRIPTION

Some traditional systems of creating images typically involves manual processes or basic software tools like graphic design software. Designers use software to create images from scratch. The creation process involves manually drawing or designing each element of the image, including shapes, colors, textures, and details. Moreover, Manual image creation can be time-consuming, especially for complex or detailed images. Designers need to invest significant effort and skill in crafting each aspect of the image.

Traditional image creation is limited by the fixed elements and designs that designers can create manually. It's challenging to incorporate dynamic or interactive elements, such as animations, real-time updates, or personalized content, without extensive manual effort. Creating high-quality images also requires advanced design skills and experience. Novice users or those unfamiliar with graphic design software may find it challenging to produce professional-looking images.

Creating multiple similar images or variations can be tedious and repetitive and cannot be easily scalable to create many images in a short frame of time. Scaling image creation to meet high demand or diverse requirements may require significant human resources and time investments. Hiring skilled designers and dedicating resources to manual image creation can be costly. The time spent on manual image creation detracts from other tasks and projects that could benefit from automation or efficient processes.

Another disadvantage is that manual processes are prone to human errors, leading to inconsistencies in image quality, style, or design elements. Maintaining version control and ensuring consistency across a series of images can be challenging without automated workflows.

Furthermore, traditional image creation often results in generic or static content that may not resonate with individual preferences or user contexts. It's difficult to create interactive or personalized images tailored to specific user inputs or dynamic scenarios.

These disadvantages highlight the limitations and challenges of the traditional system of creating images manually. They underscore the need for more efficient, scalable, and automated approaches to image generation, especially in modern applications that demand personalized and dynamic content.

The interaction system described herein mitigates and/or eliminates the disadvantages of traditional systems. The interaction system utilizes a sophisticated approach involving one or more machine learning models to streamline image creation. First, users input prompts or queries, triggering the first machine learning model to generate a second prompt that encapsulates the essence of their request.

This second prompt, such as “close up selfie: one person, wearing a chef's outfit, posing for a photo in a professional kitchen,” serves as a detailed guideline for the subsequent steps. The second machine learning model then processes this prompt to derive structured instructions that simplify and clarify the requirements, such as “chef's outfit, professional kitchen, cooking utensils, and focused expression.” These instructions act as a blueprint for the final image creation process.

Next, users provide a selfie or image that maintains their identity. These inputs are fed into the second machine learning model, which uses such input data to generate a final image that fulfills the user's request while preserving their identity. For instance, the second machine learning model may create an image of the user wearing a chef's outfit in a professional kitchen setting, incorporating elements from the reference images to enhance realism and relevance. This multi-stage approach leverages machine learning capabilities to automate and optimize image creation, ensuring personalized and high-quality results tailored to user input and preferences.

As such, the interaction system described herein automates the image generation process using machine learning models. This reduces the reliance on manual design and speeds up the creation of images. Moreover, the machine learning models in the interaction system can generate dynamic and interactive content, such as personalized images based on user input. This increases flexibility compared to fixed manual designs.

The interaction system is designed to be user-friendly, allowing users without extensive design skills to create professional-looking images. The machine learning models handle complex design tasks, reducing the skill barrier. With automation and machine learning, the interaction system can scale image creation efficiently to meet high demand or diverse requirements without significant resource investments. By automating image creation and reducing manual labor, the interaction system lowers labor costs and optimizes resource allocation.

Machine learning models ensure consistency in image quality, style, and design elements across a series of images, reducing human errors and ensuring version control. Moreover, the interaction system creates personalized content tailored to specific user inputs or scenarios. Machine learning models generate images based on user prompts, enhancing user engagement and relevance.

Overall, the interaction system revolutionizes image creation by leveraging machine learning capabilities to optimize the process, addressing the key limitations and challenges of the traditional manual approach.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in an electronic interaction process. Computing resources used by one or more machines, databases, or networks may thus be more efficiently utilized or even reduced.

### Networked Computing Environment

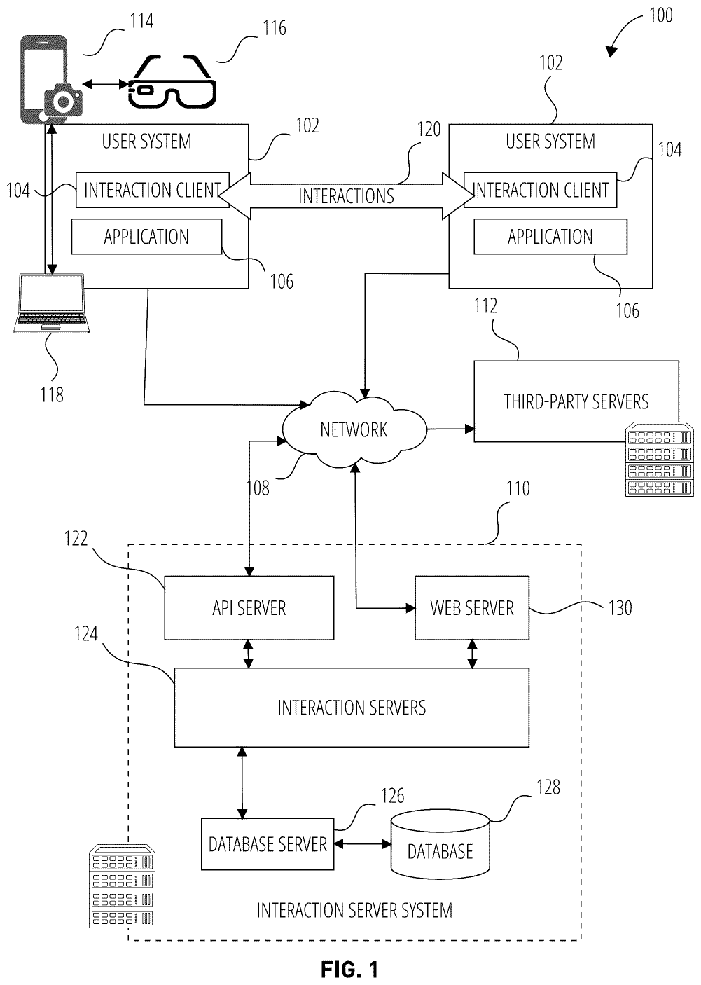

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and the other interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

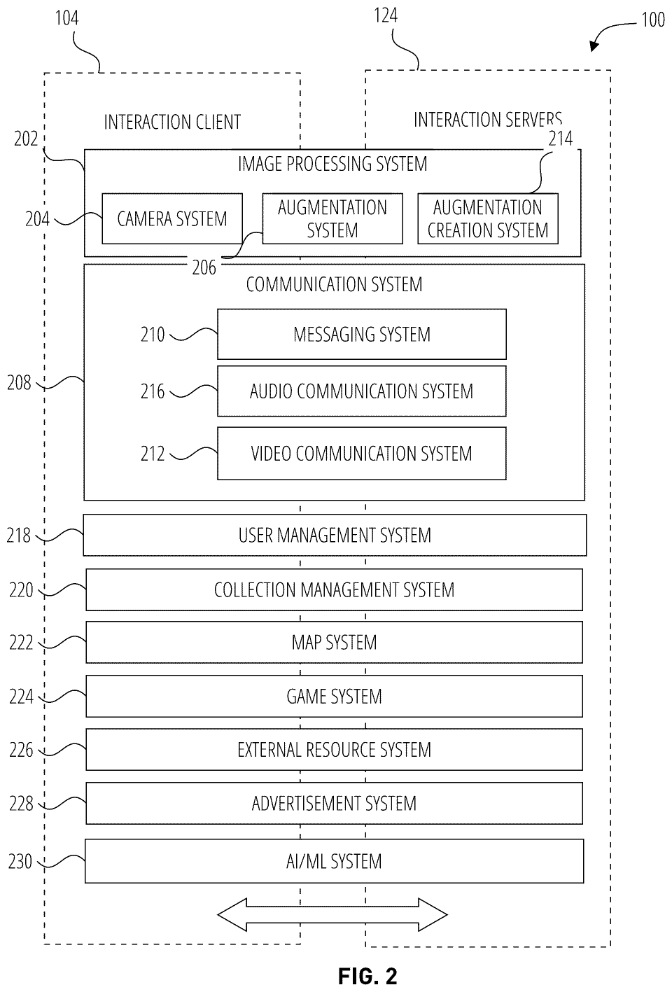

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
1. Function logic: The function logic implements the functionality of the microservice subsystem, representing a specific capability or function that the microservice provides.
2. API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
3. Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
4. Service discovery: Microservice subsystems may find and communicate with other microservice subsystems of the interaction system 100. Service discovery mechanisms enable microservice subsystems to locate and communicate with other microservice subsystems in a scalable and efficient way.
5. Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

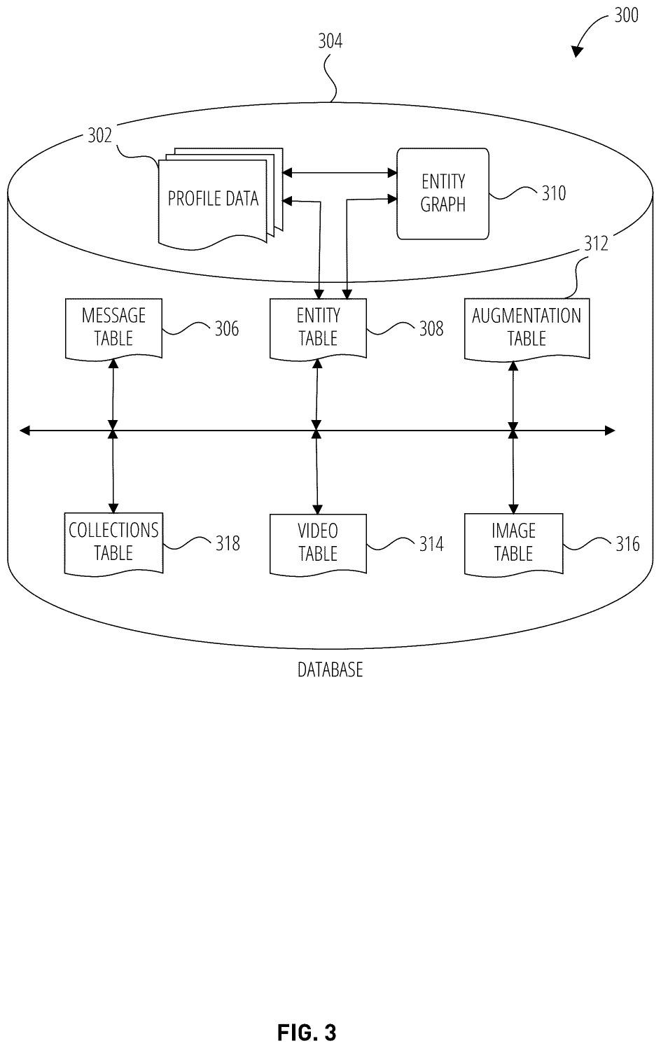

A user management system 218 is operationally responsible for the management of user data and profiles, and maintains entity information (e.g., stored in entity tables 308, entity graphs 310 and profile data 302, (FIG. 3) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated. Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation. In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

The system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, the system operating within the interaction client 104 determines the presence of a face within the image or video stream and provides modification icons associated with a computer animation model to transform image data, or the computer animation model can be present as associated with an interface described herein. The system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Generating Prompts and Images Using Machine Learning Models

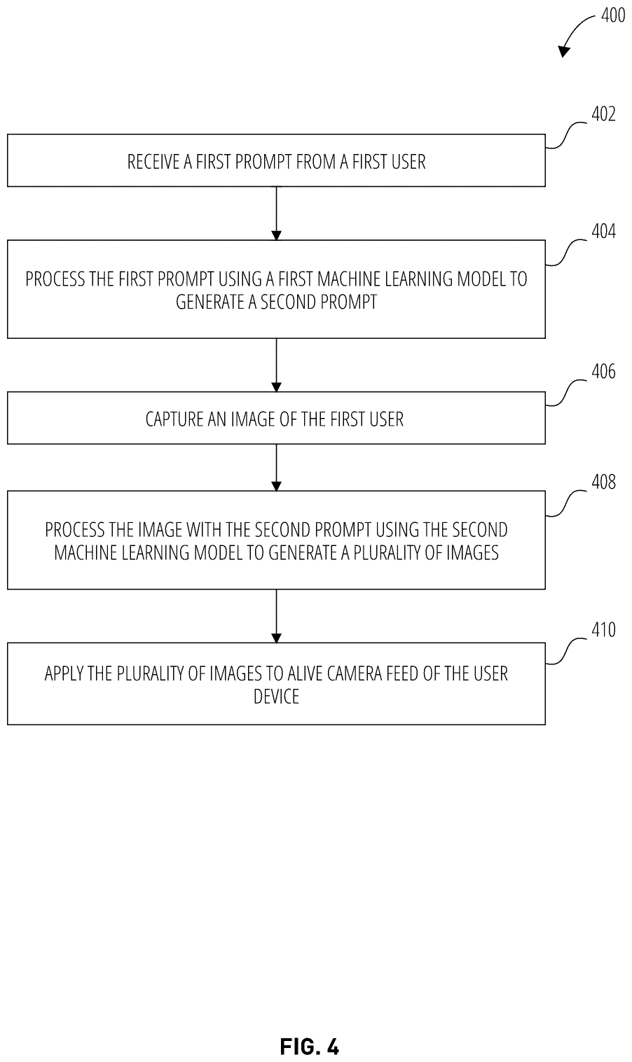

FIG. 4, a flow diagram, illustrates an example method 400 for generating a prompt using a first machine learning model and generating images using a second machine learning model, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

FIG. 4 is described as being performed by certain systems or applying certain processes, such as a particular machine learning model or computer vision model, but the processes described herein can be performed by one or more other or the same machine learning models, computer vision models, or a combination thereof.

At operation 402, the interaction system, such as interaction system 100, receives a first prompt of a first user via a user interface of a user device indicating a user's intent. The first prompt includes a request or input from the user. For example, the first prompt can include the user asking a question such as “what should I do this summer?”

The user can input the first prompt via a user interface of the application, such as in a text input box or a voice command interface. The user interface includes an interface through which the user interacts with the application. The user interface can include a mobile application interface, a web interface, or any other platform-specific interface where the user can input their question or prompt.

The first prompt indicates what the user wants from the application or an intent of the user. In the example above, the user is seeking suggestions or ideas related to activities to do in the summer.

In some examples, the interaction client 104 generates the prompt for the first user automatically based on an intent identified from real-time interaction data captured by the first interaction client. The interaction client 104 generates prompts for a user based on a user's past activity, interests, and behavior patterns, such as past interaction activity on the application. The interaction client 104 generates personalized prompts related to topics the user may find appealing, such as if a user frequently interacts with a certain type of content about technology.

In some examples, the interaction client 104 uses popular or trending topics from the platform or the wider internet to create prompts that are likely to be of interest to a broad audience. In some examples, by utilizing a user's geographic location, the interaction client 104 can generate prompts that are relevant to their local area, such as events, news, or cultural topics. In some examples, the interaction client 104 can create prompts based on the time of day, season, or upcoming events or holidays, such as events that are time sensitive. In some examples, the interaction client 104 can use the user's social connections to generate prompts related to their friends, family, or other users they follow, such as a birthday or new connection with another user. In some examples, based on the user's activity within a specific application or AR experience, the interaction client 104 can generate prompts related to that context.

In some examples, the interaction client 104 can use the user's in-application actions, such as likes, comments, and shares, to generate prompts related to their interests. For example, if a user frequently interacts with content about cooking in a recipe application, the interaction client 104 may generate a prompt for the user's favorite dish to prepare at home. In some examples, by utilizing sensors and data from the user's mobile device or AR headset, the interaction client 104 creates context-aware prompts based on their physical environment. In some examples, the interaction client 104 can generate prompts based on real-time events occurring within the application or AR experience, such as a live-streamed event. In some examples, the real-time interaction data includes a current camera feed from a camera system of the first interaction client 104.

In some examples, the interaction client 104 uses the user's past activity, preferences, and behavior patterns within the application or AR experience to generate a prompt for the user. In some examples, the interaction client 104 gathers user profile information, such as a calendar of appointments or objects detected in a camera feed of an AR device to generate a prompt. In some examples, by incorporating gamification elements, the interaction client 104 creates prompts that encourage user participation and engagement, such as checking on a feature within a game.

In some cases, the first prompt is automatically generated using a third machine learning model. The third machine learning model can process interaction data from the user as the user interacts with the system, such as liking certain photographs or posting certain interests. The third machine learning model can output an indication that the user may prefer cooking over water sports based on such interaction data. For example, the third machine learning model can include a personalized AI agent trained to receive as input interaction data across the platform and identify preferences of the user and/or generate a user identity graph of the user.

In some cases, the system receives as input the first prompt, and the system modifies the first prompt using data identified about the user from the interaction data. For example, the received prompt can include “what should I do this summer?” The system can identify that the user is interested in food based on the user's likes and photograph posts. The system can then modify the first prompt to state “what should I do this summer related to food?”

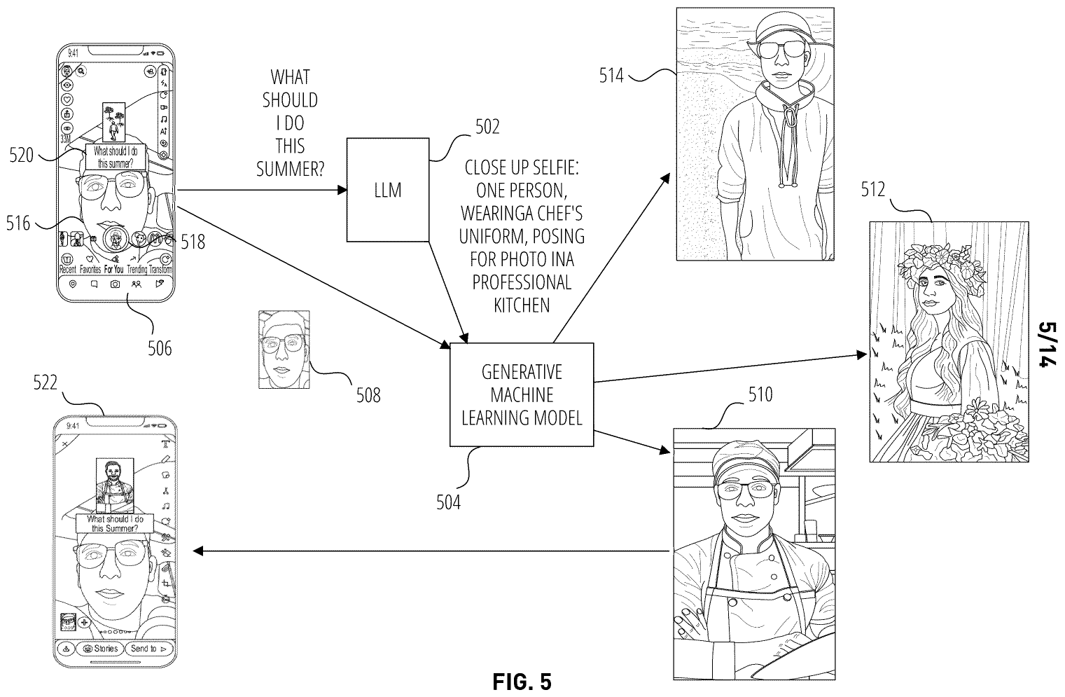

FIG. 5 illustrates an example of the generation of multiple images from a user prompt using an LLM and generative machine learning model, according to some examples. A first user 516 initiates an augmented reality experience by selecting a user interface element 518 on a user interface 506 of a user device. The user device enables the first user to input a prompt 520, such as the first prompt. For example, the user can input the text “what should I do this summer?”

Returning to FIG. 4, at operation 404, the interaction system processes the first prompt using a first machine learning model to generate a second prompt that is applied to a second machine learning model, the second prompt indicative of attributes associated with the first prompt.

The system takes the user's initial prompt, for example, “What should I do this summer,” and inputs the first prompt into a first machine learning model. The first machine learning model is trained to understand and interpret natural language inputs from users. The system can train such an LLM by first gathering a diverse and extensive dataset that includes text inputs similar to what users might provide. This dataset can include prompts, scenarios, attributes, and other relevant information related to generating augmented reality content.

The system can define the specific objective for training the LLM in this context. For example, the objective can include generating second prompts that are contextually relevant and actionable for creating augmented reality content based on user queries using a second machine learning model.

The system then trains the LLM using the preprocessed data and fine-tuning techniques. The training process includes iteratively feeding batches of data to the model, adjusting model weights based on loss calculations (how well the model predicts the correct outputs), and optimizing training parameters to improve performance.

The system validates the trained model using evaluation metrics and validation datasets. This step ensures that the model generalizes well to unseen data and produces contextually relevant and accurate second prompts for generating augmented reality content.

The first machine learning model processes the first prompt and generates a second prompt based on the attributes identified in the first prompt. This second prompt can include a refined or augmented version of the initial prompt. In other cases, the second prompt can include specific directions that respond to the query or question of the first prompt. For example, if the first prompt mentions summer activities, the second prompt might specify a scenario related to summer activities, such as posing as a chef in a professional kitchen.

The second prompt includes attributes that are directly related to or inferred from the first prompt. These attributes help to narrow down the scope and context of the user's request or query, making it more specific and actionable.

In some cases, attributes encompass descriptive details mentioned in the prompt or implied by it. The initial prompt provided by the user, such as “what should I do this summer,” contains implicit characteristics that convey the user's intent. In this example, attributes could include “summer activities,” “suggestions,” “things to do,” and so on. The machine learning model analyzes the user's prompt to extract contextual information. For instance, if the prompt mentions summer, the model infers attributes related to summer activities, weather, outdoor events, vacations, etc.

Attributes can specify particular scenarios or settings relevant to the user's query. For instance, the attribute “chef's outfit” suggests a culinary theme, while “professional kitchen” indicates a specific environment for the augmented reality experience.

Attributes may reflect user preferences or interests inferred from the prompt. For instance, if the prompt mentions “adventure,” “travel,” or “exploring,” these attributes suggest a preference for adventurous or travel-related augmented reality content.

Attributes can include actionable elements that guide the generation of prompts and augmented reality content. For example, attributes like “pose as a chef,” “capture a selfie,” “rotate images,” and “overlay images on live feed” provide actionable instructions for creating engaging experiences.

In the example of FIG. 5, the user provides an initial prompt, which is “what should I do this summer?” This prompt indicates the user's intent to seek suggestions or ideas for summer activities. The first prompt “what should I do this summer?” is inputted into a LLM 502 to generate a second prompt.

LLM 502 processes the initial prompt and generates a second prompt based on the input. The second prompt is designed to be more specific and actionable, tailored to the context of the content augmentations and/or augmented reality experiences. The generated second prompt is “close up selfie: one person, wearing a chef's uniform, posing for a photo in a professional kitchen.” This second prompt includes several attributes and details inferred from the initial prompt:
1. Close-up Selfie: Indicates that the generated content will involve a close-up photo of the user.
2. One Person: Specifies that the scenario is focused on a single individual, which is the user.
3. Wearing a Chef's Uniform: Adds a specific element to the scenario, indicating that the user will be depicted as wearing a chef's uniform.
4. Posing for Photo: Implies that the generated content should involves posing for a photo, suggesting a dynamic and interactive element.
5. In a Professional Kitchen: Sets the scene for the augmented reality content, indicating that the user will be placed in a professional kitchen environment.

The second prompt is contextualized based on attributes related to summer activities (from the initial prompt) and is designed to guide the creation of augmented reality content that aligns with the user's query. It provides actionable instructions for generating immersive and engaging augmented reality experiences.

Returning to FIG. 4, at operation 406, the interaction system captures an image of the first user via a live camera feed of the user device. The interaction system accesses the live camera feed of the user's device, which could be a smartphone, tablet, or any other device capable of capturing images in real-time using a built-in camera.

The first user includes the user who initiated the interaction by providing the initial prompt, such as “what should I do this summer,” which led to the generation of a second prompt and the subsequent augmented reality content. The user can face the camera to the first user's head and the system can capture an image of the user's head. The interaction system captures a still image from the live camera feed. This image serves as a reference point for generating augmented reality content that interacts with the user's environment in real-time.

The live camera feed includes a real-time video feed captured by the user's device camera. The live camera feed provides the raw visual data that the interaction system uses to create augmented reality experiences. Capturing the user's image from the live camera feed allows the interaction system to overlay augmented reality elements, such as the chef's outfit and professional kitchen environment, onto the user's live video feed. This integration creates a seamless and immersive augmented reality experience aligned with the user's query and preferences.

In FIG. 5, the system captures a still image of the user via the user interface. The system then extracts the user's head 508 from the still image for processing by the second machine learning model.

The system can apply a face detection algorithm to identify and locate the user's face within the still image captured from the live camera feed, such as applying computer vision techniques, deep learning models, or deep neural networks that are capable of accurately detecting faces in images.

Once the face is detected, the system crops the image to focus specifically on the region containing the user's head. This step helps isolate the head from the rest of the image, reducing unnecessary information and improving processing efficiency.

In some cases, the system may perform face alignment to ensure that the extracted head is properly aligned and oriented. This step helps standardize the head's position and angle for further processing. In some cases, the system may perform normalization techniques, such as adjusting brightness, contrast, and color balance, to the extracted head image which can help improve the quality and consistency of the input data for the second machine learning model.

Using facial landmark detection algorithms, the system can identify key facial features such as eyes, nose, mouth, and contours of the face. This information can be valuable for the second machine learning model for generating realistic and accurate augmented reality overlays on the user's head. In other cases, the image without the key facial features are inputted into the machine learning model. In some cases, the system may also perform texture mapping to capture detailed textures and characteristics of the user's head, ensuring that the augmented reality elements blend seamlessly with the user's appearance.

Returning to FIG. 4, at operation 408, the interaction system processes a combination of the image of the first user with the second prompt using the second machine learning model to generate a plurality of images. The image refers to the still image of the user captured by the user device, specifically focusing on the user's head as extracted and processed from the live camera feed. This image serves as a visual reference for generating augmented reality content.

The interaction system inputs a combination of the processed image of the first user's head with the second prompt into the second machine learning model for processing. The second prompt provides contextual information to the machine learning model about the desired augmented reality scenario, such as the user's appearance, environment, actions, and any additional elements required for the augmented reality experience.

The second machine learning model is trained to generate augmented reality content based on input data such as the combined image of the user's head and the second prompt. The model uses this input to generate one or more images that align with the specified scenario. These images may vary in terms of poses, outfits, backgrounds, or other elements, creating a diverse set of augmented reality content. The machine learning model generates a plurality of images ensures that there are multiple options and variations for the augmented reality content. This enhances the user experience by providing a range of visual choices and interactions.

The plurality of images can include dynamic elements, such as animated sequences, rotating images, or interactive overlays, adding to the richness and engagement of the augmented reality experience. Users may have preferences for specific poses, styles, or settings. The plurality of images allows for customization and personalization, catering to diverse user preferences and scenarios.

In some cases, the machine learning model is trained to automatically generate multiple images. In other cases, the system runs the machine learning model multiple times to generate the multiple images.

In some cases, the second machine learning model includes a diffusion model, such as a stable diffusion model, or other model that can convert textual input into an image or video.

The stable diffusion model takes as input the combined data from the user's image (specifically the head region) and the second prompt. This input serves as the initial condition for generating the desired images.

The model first extracts features from the user's head image, such as facial landmarks (eyes, nose, mouth) and overall facial structure. This information helps the model understand the geometry and appearance of the user's head.

The stable diffusion model incorporates the contextual information provided by the second prompt. For example, if the prompt specifies wearing a chef's outfit and posing in a professional kitchen, the model understands the desired augmented reality scenario.

The stable diffusion model employs diffusion-based techniques to generate images that align with the specified scenario. This process involves iteratively updating pixel values based on neighboring pixels and contextual information, gradually refining the image.

The model adds augmented elements, such as the chef's outfit and professional kitchen background, to the generated images. These elements are seamlessly integrated with the user's head image, creating a realistic and immersive augmented reality experience.

The stable diffusion model is trained to pay attention to texture and detail, ensuring that the augmented elements blend naturally with the user's appearance and the virtual environment depicted in the second prompt.

In stable diffusion models, noise refers to random perturbations or variations introduced into the initial image or data. This noise is typically generated using random number generators or stochastic processes. The stable diffusion model introduces noise to add randomness into the image generation process, preventing the model from converging to a single solution and ensuring diversity in the generated images, encourages exploration to explore different possibilities and variations, leading to more creative and diverse outputs, and enhances realism by adding subtle variations and imperfections that contribute to the realism of the generated images, making them appear more natural and visually appealing.

The second machine learning model can use diffusion equations or diffusion processes to iteratively update pixel values in the image based on neighboring pixels and input data. Noise is incorporated into the diffusion process by adding it to the pixel values or as a component in the iterative updates. This results in random fluctuations and variations in the image during the generation process.

In FIG. 5, the generative machine learning model 504, such as a stable diffusion model, receives as input the image of user's head 508 of the first user and the second prompt “close up selfie: one person, wearing a chef's uniform, posing for photo in a professional kitchen.” The second machine learning model generates a first image 510 of a chef in a professional kitchen, a second image 512 of the user in the forest, and a third image 514 of the user on the beach.

In some cases, the first image 510 is selected and displayed above the head of the user, such as in user interface 522.

Returning to FIG. 4, at operation 410, the interaction system applies the plurality of images to the live camera feed of the user device. The system overlays the generated augmented reality elements onto the live camera feed, precisely aligning the images with the user's head position and movements. This creates a seamless and interactive augmented reality experience where the user appears as a chef in a professional kitchen. This integration creates a dynamic and interactive augmented reality experience.

In some cases, the first machine learning model generates a plurality of second prompts to choose from, indicative of different scenarios that answer the question in the first prompt “what should I do this summer?” For example, the first machine learning model can generate the following:
1. “Close up selfie: one person, wearing a chef's uniform, posing for a photo in a professional kitchen.”
2. “Outdoor adventure selfie: one person, dressed in hiking gear, exploring a mountain trail with scenic views in the background.”
3. “Beach vacation selfie: one person, wearing a swimsuit, relaxing on a tropical beach with palm trees and crystal-clear waters.”
4. “Cultural experience selfie: one person, in traditional attire, participating in a cultural festival with vibrant decorations and performances.”
5. “Urban exploration selfie: one person, in casual city attire, discovering street art and trendy cafes in a bustling cityscape.”

The system can then select among the plurality of scenarios that were generated. In some cases, the system selects a scenario at random. In other cases, the system selects a scenario that best fits the identity graph generated by the third machine learning model (further described herein). For example, the user identify graph can indicate a preference for food, and as such, the system may select #1 scenario above over the other scenarios, as the #1 scenario above relates to food.

In some cases, the system processes each of the scenarios through the second machine learning model to generate images for each of the scenarios. In such cases, each of the images that relate to different scenarios can be applied to the live camera feed of the user device, such as rotating through each image (as further described herein).

Individual images are rotated above the head of the user in the live camera feed. The system takes the plurality of generated images (from the stable diffusion model or similar image generation process) and begins rotating them above the head of the user in the live camera feed. This rotation serves as a dynamic and interactive element, allowing the user to see different variations of augmented reality content in real-time.

Simultaneously, the system starts recording the live camera feed along with the rotating images. This recording captures the user's interaction with the augmented reality elements. Initially, the rotation speed of the images may be relatively fast, creating a dynamic and visually engaging effect. However, as the recording continues, the speed of rotation gradually slows down.

Once the rotation speed slows down significantly, the system selects one image from the rotating set as the final recommendation. In some cases, the final image selection can be based on user feedback (e.g., the user pressing a button or opens his mouth). In other cases, the selection is algorithmically determined (e.g., based on image analysis or user preferences).

The final selected image is presented above the user's head in the live camera feed. This image represents the recommended augmented reality content based on the user's input and the system's processing.

Extended Reality (XR) is an umbrella term encapsulating Augmented Reality (AR), Virtual Reality (VR), Mixed Reality (MR), and everything in between. For the sake of simplicity, examples are described using one type of system, such as XR or AR. However, it is appreciated that other types of systems apply.

As described herein, one or more machine learning models can apply interaction data of a user to identify preferences or an identify graph of a user. Such interaction data can be captured by a user's historical interaction with interaction functions.

In some examples, interaction functions include user interaction with a camera feed displayed on the user system 102, such as selecting a real-world object on a camera feed or selecting a digital item or overlay shown on the camera feed. In some examples, interaction functions also include a chat window where messages, stickers, emojis, and other media content items are shared between users via user systems 102.

Interaction functions further include sending photos or videos to friends, either individually or in groups, which are edited with text, stickers, filters, and drawings before being sent. Interaction functions include capturing a video or audio, inputting text, or other communications that disappear after certain conditions are met, such as being viewed once or setting a time limit, creating a more ephemeral and casual sharing experience.

In some examples, interaction functions include generating or viewing a collection of videos, messages, stickers, or other media content items that are visible to friends for a certain period of hours (e.g., 24 hours). Interaction functions include displaying media content items from other users, such as publishers, creators, and influencers, where users explore and subscribe to different channels to receive updates on their favorite content. Interaction functions include map and location functions, such as users sharing their location with friends and viewing their friends' locations on a map, or exploring a map with points of interest by other users categorized by location and events.

In some examples, interaction functions include generating or applying various filters and content augmentations to enhance images, videos, or other media content items to share with others, such as by adjusting the color or appearance or adding interactive elements such as animations and facial transformations, in real-time. Interaction functions include saving favorite media content items with other users in a private archive, where users access these saved media content items later, edit them, or share them with friends.

Interaction functions include personalizing or applying avatars which are used as a profile picture to be viewed by others and in stickers, chat, and image/video decorations. Interaction functions include playing multiplayer games that users play with their friends directly within the user interface of the system to share messages and media content items.

Interaction functions include capturing data by an Augmented Reality (AR) device. In some examples, the interaction system 100 captures motion and position data, such as data from accelerometers, gyroscopes, and magnetometers to track user movement or orientation. In some examples, the interaction system 100 captures eye-tracking data which monitors the user's eye movements and focus, gaze-based interactions, objects the user is focused (or not focused) on, or user attention patterns.

In some examples, the interaction system 100 captures facial expressions. In some examples, the interaction system 100 captures biometric data, such as heart rate, body temperature, or skin conductivity. In some examples, the interaction system 100 captures data related to user interactions within the virtual or augmented environment, such as objects or buttons users interact with, the time spent in specific areas, or the choices users make. In some examples, the interaction system 100 captures voice data, voice recognition, voice commands, and/or the like. In some examples, the interaction system 100 captures location data, such as a user's GPS location. In some examples, the interaction system 100 captures usage data related to how and when the devices are used, session duration, frequency of use, and user engagement with specific content or applications.

In some cases, the second machine learning model is trained to generate content media items based on the second prompt and user image. The media content items can include:
1. Content augmentations to enhance images, videos, or other media content items to share with others, such as by adjusting the color or appearance or adding interactive elements such as animations and facial transformations, in real-time.
2. Emojis that are small images or icons that represent emotions, reactions, or objects.
3. Stickers are larger images or animations that can be sent in a chat window.
4. Images or photographs can be sent to other users to share visual information or document a particular event.
5. Video clips can be used to share recorded content or document a particular event.
6. Audio messages can be shared to communicate audible communication.
7. Graphics Interchange Formats (GIFs) are short animations that can be used to add humor or express emotions.

Systems and methods described herein include training a machine learning network, such as training to generate second prompts or media content items. The machine learning network can be trained to generate media content items based on second prompt data and an image or video of the user. The machine learning algorithm can be trained using historical information that include historical prompts and images, and resulting media content items.

Training of models, such as artificial intelligence models, is necessarily rooted in computer technology, and improves modeling technology by using training data to train such models and thereafter applying the models to new inputs to make inferences on the new inputs. Here, the new inputs can be a new query in the form of a first prompt. The trained machine learning model can generate new images never created before using the first prompt and a user's image.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new interaction data) and make predictions that the model was trained for based on the weights or scores that were adjusted during training. Such training of the machine learning models described herein reduces false positives and increases the performance of generating relevant content items within interaction data of the user.

### Example User Interfaces of Generative Images Responsive to User Prompt

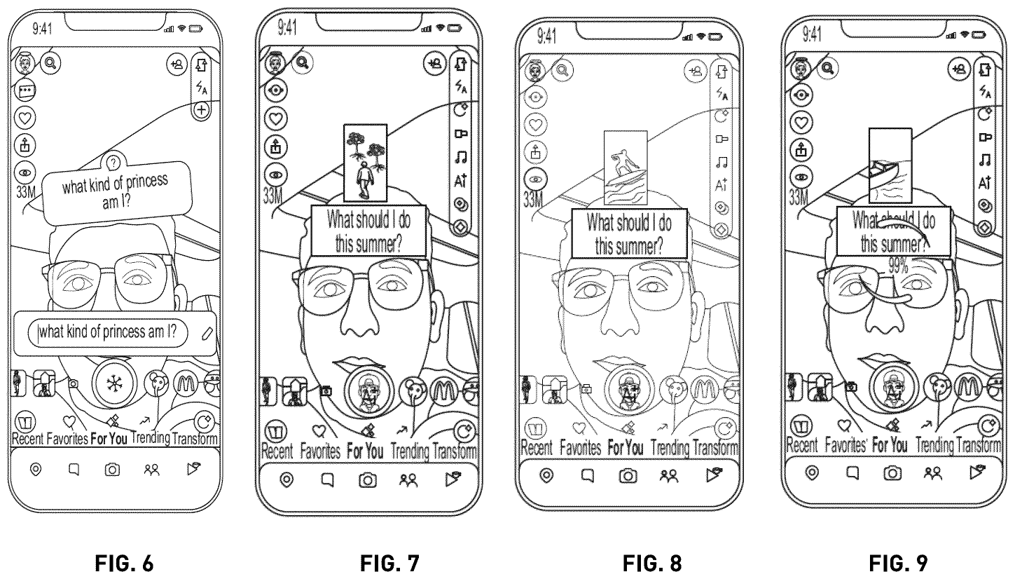

FIG. 6 illustrates a user interface enabling a user to input a first prompt, according to some examples. The user interface includes a text input field where the user can type their first prompt. This field can include a submit button or an enter key to indicate that the input is complete. For example, the user may type “What's the best hiking trail near me?” as their first prompt.

FIG. 7 illustrates a user interface displaying a live camera feed of a user device and receiving of a user prompt, according to some examples. The user interface displays a live camera feed capturing the user's real-time video. The user interacts with the interface by appearing in front of the camera and providing a spoken or typed prompt. In this case, the prompt is “what should I do this summer?”

The main area of the interface shows the live video feed from the user's device camera. A text input field or voice command prompt is visible, indicating where the user can input their question or query. The user interface includes visual indicators such as buttons, icons, or text prompts guiding the user to input their question or interact with the interface.

The interface is designed to recognize and process the user's input prompt. In this case, the prompt “what should I do this summer?” triggers the subsequent stages of the augmented reality experience. The interface allows for real-time interaction, capturing the user's actions and input immediately as they occur. The user's prompt sets the context for the augmented reality experience, providing information that will be used to generate recommendations or content.

The live camera feed engages the user by incorporating their real-world presence into the augmented reality experience. This stage marks the beginning of the interaction, prompting the user to ask a question or provide input that will lead to the generation of recommended images or content.

FIG. 8 illustrates a user interface indicating an image captured by the user device, according to some examples. The user interface shows a change in the screen color, such as turning slightly white or displaying a white overlay. This visual change serves as an indicator that a picture has been taken or captured from the live camera feed.

The primary element of this interface stage is the change in screen color to white. This change is noticeable and serves as a clear signal to the user. The white screen appears briefly after the user inputs their prompt and before the loading screen (next stage) appears. It indicates the completion of capturing the initial image. The white screen serves as feedback to the user, confirming that their prompt has been processed and an image has been captured successfully.

The interface captures a still image from the live camera feed of the user after they input their prompt. This image will be used as a reference or input for the subsequent stages of the augmented reality experience. This user interface also acts as a transition marker between the input stage (prompt submission) and the processing stage (loading screen).

FIG. 9 illustrates a user interface that indicates loading of the generative AI processing, according to some examples. The user interface displays a loading screen, indicating that the generative AI (Artificial Intelligence) is processing and creating recommended images or content based on the user's input. This screen communicates to the user that the system is actively working on generating personalized recommendations or content.

The primary element of this interface stage is the loading animation, which typically includes a spinning wheel, progress bar, or other visual cues indicating processing activity. The loading screen may also include text or an icon indicating that the system is processing the user's request or input.

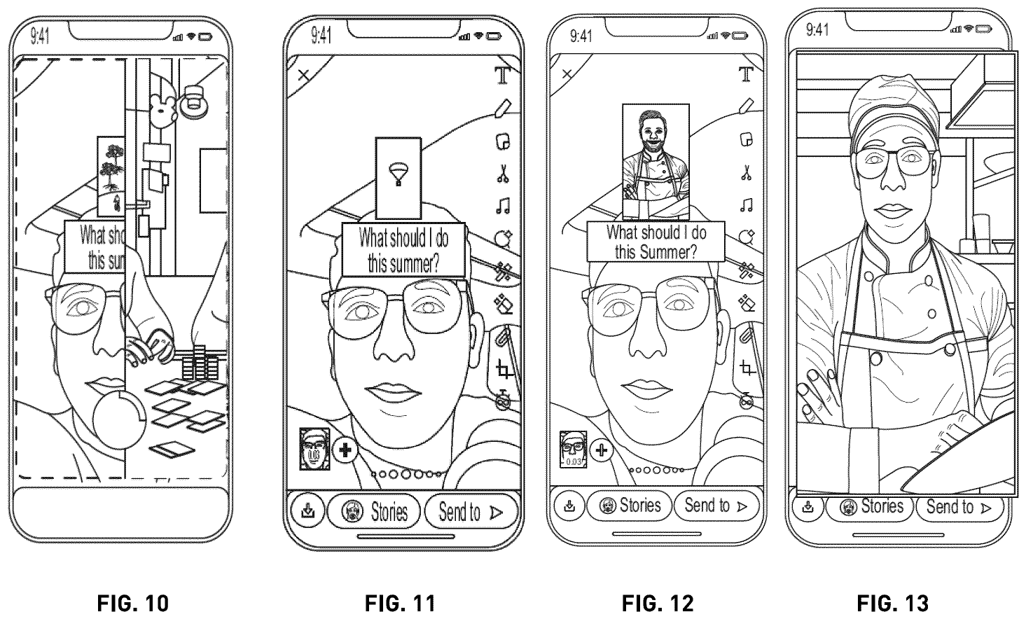

FIG. 10 illustrates video recording of a rotation of the generated images that were responsive to the user's prompt, according to some examples. The user interface displays an outline or border around the interface elements, indicating that the video is being recorded. The generated images are then rotated above the user's head. FIG. 11 illustrates a user interface where the generated images are still rotating from FIG. 10, according to some examples.

FIG. 12 illustrates a user interface including the user with the selected recommendation responsive to the user query, according to some examples. The user interface shows that the rotation speed of the images above the user's head slows down gradually. Eventually, one image is selected as the final recommendation, and it is displayed prominently above the user's head.

The system dynamically adjusts the rotation speed of the images based on predefined criteria or user interaction. This adjustment ensures that the final recommendation is presented at an appropriate pace. The system selects one image from the rotating set as the final recommendation. This selection may be based on user feedback, algorithmic analysis, or predefined criteria (as further described herein).

In some cases, the image displayed in FIG. 12 is an image that does not track the identity of the user. The user is a stable diffusion model created user of a virtual user that looks like a human. FIG. 13 illustrates a user interface that includes the generated image that tracks the identity of the user, according to some examples. The creation of such images are further described herein.

In some cases, the generative images displayed above the user's head is based on the initial image capturing the face of the user in FIG. 7. In some cases, the system generates such images in real time such that the rotating images reflect the face displayed in the live camera feed. For example, if a new user were to appear on the live video stream, the system would automatically change the generated image to reflect the face of the new user.

### Refinement of Generative Content Item Creation

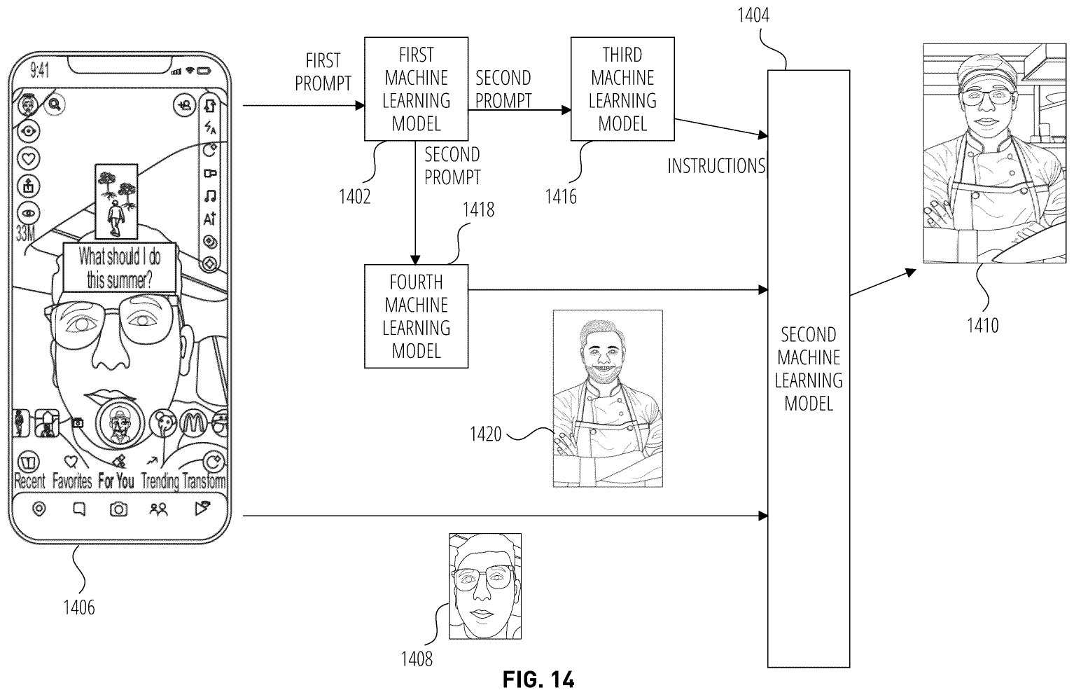

FIG. 14 illustrates an architecture for refining the generative content item creation, according to some examples. Similar to FIG. 5, the architecture in FIG. 14 includes a user interface 1406 configured to capture an image 1408 of the user and receive a first prompt, a first machine learning model 1402 configured to derive a second prompt from the first prompt, and a second machine learning model 1404 to generate a final image 1410 that maintains the identity of the user.

FIG. 14 further includes a third machine learning model 1416, a fourth machine learning model 1418, and an image 1420 that includes composition and pose information of a person that the machine learning model created, and that does not maintain the identity of the user.

The first machine learning model generating a second prompt based on the user's initial input or query. This second prompt contains attributes and details related to the user's request or scenario. The second prompt, such as “close up selfie: one person, wearing a chef's outfit, posing for a photo in a professional kitchen,” is then inputted into the third machine learning model.

The third machine learning model further processes the second prompt to generate instructions that are straightforward and detailed. The third machine learning model extracts specific elements and attributes from the second prompt to create a set of instructions that are easier for the second machine learning model to understand and act upon. The third machine learning model can include an LLM or other model that is trained to receive the second prompt as input and generate instructions that can be applied by the second machine learning model.

The output from the third machine learning model could include specific instructions for the desired image, such as “chef's outfit, professional kitchen, cooking utensils, stainless steel appliances, culinary tools, chef's hat, apron, focused expression, kitchen environment.” These instructions capture the essence and details of the desired augmented reality scenario in a simplified and structured format. The derived instructions serve as a guide or blueprint for creating the desired augmented reality content. They provide clear and specific information about the elements, attributes, and style required for generating the image or scene.

The derived instructions are then inputted into the second machine learning model. This model is trained to generating images or content based on structured input data, such as the instructions derived from the third model. The second machine learning model uses the structured instructions as input to create an image of a chef in a chef's outfit with a chef's hat in a professional kitchen with background kitchen items, such has stainless steel appliances, culinary tools, and cooking utensils.

The output is an image that aligns closely with the user's request and the specific attributes outlined in the derived instructions. The image captures the desired scene or scenario in an augmented reality context.

In some cases, a fourth machine learning model is used to generate pose and composition data for the second machine learning model. First, the first machine learning model generating a second prompt based on the user's initial input, such as “close up selfie: one person, wearing a chef's outfit, posing for a photo in a professional kitchen.”

The fourth machine learning model, which could be a stable diffusion model or similar, receives as input the second prompt from the third model as input. In some cases, the fourth machine learning model receives as input the instructions generated by the third machine learning model.

The fourth machine learning model generates one or more images of a chef in a professional kitchen setting based on the provided instructions. These images include pose and composition information relevant to the chef scenario but do not maintain the identity of the user.

The second machine learning model can receive a plurality of inputs. For example, the second machine learning model can receive one or more of the following inputs:
1. The derived instructions from the third model (e.g., “chef's outfit, professional kitchen, cooking utensils . . . ”).
2. The image(s) generated by the fourth model, which depict a chef but do not include the user's identity.
3. A selfie of the user, which provides the user's identity and facial features.

The second machine learning model combines these inputs to generate the final image of a chef that maintains the identity of the user. The second machine learning model uses the pose and composition information from the generated chef images along with the user's selfie to create a customized image where the user's face is placed on the chef's body in the professional kitchen setting. The final image is a seamless blend of the user's identity and the desired scenario of being a chef in a professional kitchen, fulfilling the user's request while personalizing the experience.

The fourth machine learning model focuses on generating images of the desired scenario (e.g., chef in a kitchen) without specific user identity. The second machine learning model utilizes these generated images, along with user identity information, to create a customized final image that combines the scenario details with the user's face, ensuring a personalized and immersive augmented reality experience. This multi-stage process enhances the realism and relevance of the final image by incorporating specific scenario elements and maintaining user identity.

In some cases, there is a database of a plurality of different images and/or data including pose and composition. For example, there may be a database of many images of different framings, poses, head tilt, arm positions, and/or the like. The output of a machine learning model can then be used to match certain keywords or embeddings to the best matched pose and composition data. In some cases, the system randomly choses among the different poses and compositions. In some cases, the system narrows down a set of poses and compositions and selects among the subset of poses and compositions, such as randomly.

In some cases, negative prompts can be inputted to one or more machine learning models as described herein, such as to generating low-quality or inappropriate content (e.g., nudity or suggestive outfits). The first machine learning model, responsible for generating prompts based on user input, can be trained to recognize and filter out negative prompts. Negative prompts could include terms related to explicit content, violence, discrimination, or any content that goes against platform policies or ethical guidelines. When a user inputs a prompt, the first model checks if it contains any negative elements. If so, it either rejects the prompt or modifies it to align with acceptable content standards.

The third machine learning model, which derives structured instructions from the second prompt, can also incorporate filters for negative content. If the second prompt contains elements that could lead to low-quality or inappropriate content (e.g., suggestive outfits), the third model adjusts the derived instructions to avoid including such elements. For example, if the second prompt mentions a “revealing outfit,” the third model may modify it to “appropriate attire” or “professional attire” to ensure the generated content meets quality and policy standards.

The fourth machine learning model, responsible for generating images based on instructions, follows guidelines to avoid generating negative or inappropriate images. These guidelines may include constraints on clothing styles, poses, backgrounds, and overall content themes to ensure compliance with platform policies and ethical standards. The model also incorporates quality checks to avoid generating low-quality or aesthetically undesirable images, such as blurry or distorted content.

In some cases, the images that do not maintain the identity of the user can be used by features of the application. For example, such images can be used to create non-player characters in a video game, in the AR/VR context, or as background in a content augmentation.

For the sake of brevity, the disclosure is described as using a particular machine learning model, or outputting prompts or images, but it is appreciated that the processes described herein can be performed differently, such as via different machine learning models, a single machine learning model being able to perform the steps of individual machine learning models or vice versa, a machine learning model outputting a video or a three dimensional avatar.

### Data Communications Architecture

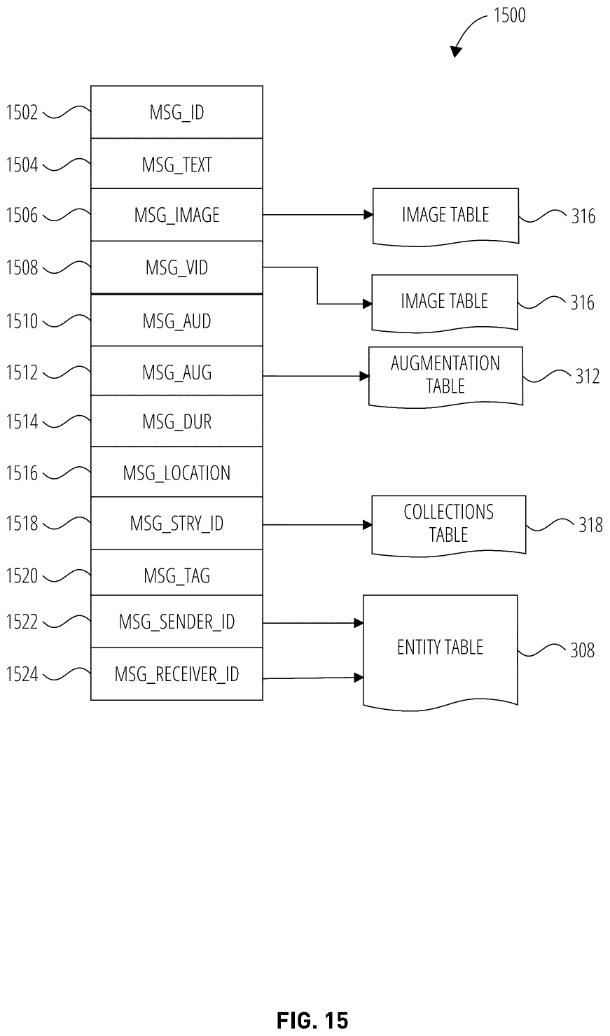

FIG. 15 is a schematic diagram illustrating a structure of a message 1500, according to some examples, generated by an interaction client 104 for communication to a further interaction client 104 via the interaction servers 124. The content of a particular message 1500 is used to populate the message table 306 stored within the database 304, accessible by the interaction servers 124. Similarly, the content of a message 1500 is stored in memory as “in-transit” or “in-flight” data of the user system 102 or the interaction servers 124. A message 1500 is shown to include the following example components:
1. Message identifier 1502: a unique identifier that identifies the message 1500.
2. Message text payload 1504: text, to be generated by a user via a user interface of the user system 102, and that is included in the message 1500.
3. Message image payload 1506: image data, captured by a camera component of a user system 102 or retrieved from a memory component of a user system 102, and that is included in the message 1500. Image data for a sent or received message 1500 may be stored in the image table 316.
4. Message video payload 1508: video data, captured by a camera component or retrieved from a memory component of the user system 102, and that is included in the message 1500. Video data for a sent or received message 1500 may be stored in the image table 316.
5. Message audio payload 1510: audio data, captured by a microphone or retrieved from a memory component of the user system 102, and that is included in the message 1500.
6. Message augmentation data 1512: augmentation data (e.g., filters, stickers, or other annotations or enhancements) that represents augmentations to be applied to message image payload 1506, message video payload 1508, or message audio payload 1510 of the message 1500. Augmentation data for a sent or received message 1500 may be stored in the augmentation table 312.
7. Message duration parameter 1514: parameter value indicating, in seconds, the amount of time for which content of the message (e.g., the message image payload 1506, message video payload 1508, message audio payload 1510) is to be presented or made accessible to a user via the interaction client 104.
8. Message geolocation parameter 1516: geolocation data (e.g., latitudinal and longitudinal coordinates) associated with the content payload of the message. Multiple message geolocation parameter 1516 values may be included in the payload, each of these parameter values being associated with respect to content items included in the content (e.g., a specific image within the message image payload 1506, or a specific video in the message video payload 1508).
9. Message story identifier 1518: identifier values identifying one or more content collections (e.g., “stories” identified in the collections table 318) with which a particular content item in the message image payload 1506 of the message 1500 is associated. For example, multiple images within the message image payload 1506 may each be associated with multiple content collections using identifier values.
10. Message tag 1520: each message 1500 may be tagged with multiple tags, each of which is indicative of the subject matter of content included in the message payload. For example, where a particular image included in the message image payload 1506 depicts an animal (e.g., a lion), a tag value may be included within the message tag 1520 that is indicative of the relevant animal. Tag values may be generated manually, based on user input, or may be automatically generated using, for example, image recognition.
11. Message sender identifier 1522: an identifier (e.g., a messaging system identifier, email address, or device identifier) indicative of a user of the user system 102 on which the message 1500 was generated and from which the message 1500 was sent.
12. Message receiver identifier 1524: an identifier (e.g., a messaging system identifier, email address, or device identifier) indicative of a user of the user system 102 to which the message 1500 is addressed.

The contents (e.g., values) of the various components of message 1500 may be pointers to locations in tables within which content data values are stored. For example, an image value in the message image payload 1506 may be a pointer to (or address of) a location within an image table 316. Similarly, values within the message video payload 1508 may point to data stored within an image or video table 316, values stored within the message augmentation data 1512 may point to data stored in an augmentation table 312, values stored within the message story identifier 1518 may point to data stored in a collections table 318, and values stored within the message sender identifier 1522 and the message receiver identifier 1524 may point to user records stored within an entity table 308.

### System with Head-Wearable Apparatus

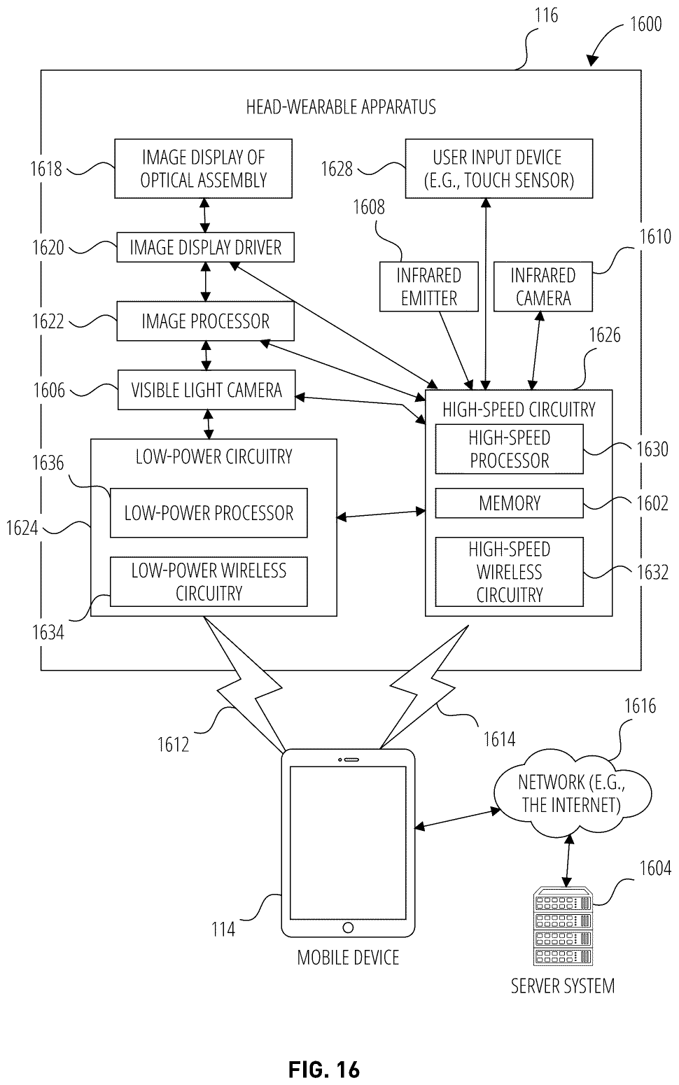

FIG. 16 illustrates a system 1600 including a head-wearable apparatus 116 with a selector input device, according to some examples. FIG. 16 is a high-level functional block diagram of an example head-wearable apparatus 116 communicatively coupled to a mobile device 114 and various server systems 1604 (e.g., the interaction server system 110) via various networks. The networks 108 may include any combination of wired and wireless connections.

The head-wearable apparatus 116 includes one or more cameras, each of which may be, for example, a visible light camera 1606, an infrared emitter 1608, and an infrared camera 1610.

An interaction client, such as a mobile device 114 connects with head-wearable apparatus 116 using both a low-power wireless connection 1612 and a high-speed wireless connection 1614. The mobile device 114 is also connected to the server system 1604 and the network 1616.

The head-wearable apparatus 116 further includes two image displays of the image display of optical assembly 1618. The two image displays of optical assembly 1618 include one associated with the left lateral side and one associated with the right lateral side of the head-wearable apparatus 116. The head-wearable apparatus 116 also includes an image display driver 1620, an image processor 1622, low-power circuitry 1624, and high-speed circuitry 1626. The image display of optical assembly 1618 is for presenting images and videos, including an image that can include a graphical user interface to a user of the head-wearable apparatus 116.

The image display driver 1620 commands and controls the image display of optical assembly 1618. The image display driver 1620 may deliver image data directly to the image display of optical assembly 1618 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1628 (e.g., touch sensor or push button), including an input surface on the head-wearable apparatus 116. The user input device 1628 (e.g., touch sensor or push button) is to receive from the user an input selection to manipulate the graphical user interface of the presented image.

The components shown in FIG. 16 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1606 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1602, which stores instructions to perform a subset or all of the functions described herein. The memory 1602 can also include storage device.

As shown in FIG. 16, the high-speed circuitry 1626 includes a high-speed processor 1630, a memory 1602, and high-speed wireless circuitry 1632. In some examples, the image display driver 1620 is coupled to the high-speed circuitry 1626 and operated by the high-speed processor 1630 in order to drive the left and right image displays of the image display of optical assembly 1618. The high-speed processor 1630 may be any processor capable of managing high-speed communications and operation of any general computing system needed for the head-wearable apparatus 116. The high-speed processor 1630 includes processing resources needed for managing high-speed data transfers on a high-speed wireless connection 1614 to a wireless local area network (WLAN) using the high-speed wireless circuitry 1632. In certain examples, the high-speed processor 1630 executes an operating system such as a LINUX operating system or other such operating system of the head-wearable apparatus 116, and the operating system is stored in the memory 1602 for execution. In addition to any other responsibilities, the high-speed processor 1630 executing a software architecture for the head-wearable apparatus 116 is used to manage data transfers with high-speed wireless circuitry 1632. In certain examples, the high-speed wireless circuitry 1632 is configured to implement Institute of Electrical and Electronic Engineers (IEEE) 802.11 communication standards, also referred to herein as WI-FI®. In some examples, other high-speed communications standards may be implemented by the high-speed wireless circuitry 1632.

The low-power wireless circuitry 1634 and the high-speed wireless circuitry 1632 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1612 and the high-speed wireless connection 1614, may be implemented using details of the architecture of the head-wearable apparatus 116, as can other elements of the network 1616.

The memory 1602 includes any storage device capable of storing various data and applications, including, among other things, camera data generated by the left and right visible light cameras 1606, the infrared camera 1610, and the image processor 1622, as well as images generated for display by the image display driver 1620 on the image displays of the image display of optical assembly 1618. While the memory 1602 is shown as integrated with high-speed circuitry 1626, in some examples, the memory 1602 may be an independent standalone element of the head-wearable apparatus 116. In certain such examples, electrical routing lines may provide a connection through a chip that includes the high-speed processor 1630 from the image processor 1622 or the low-power processor 1636 to the memory 1602. In some examples, the high-speed processor 1630 may manage addressing of the memory 1602 such that the low-power processor 1636 will boot the high-speed processor 1630 any time that a read or write operation involving memory 1602 is needed.

As shown in FIG. 16, the low-power processor 1636 or high-speed processor 1630 of the head-wearable apparatus 116 can be coupled to the camera (visible light camera 1606, infrared emitter 1608, or infrared camera 1610), the image display driver 1620, the user input device 1628 (e.g., touch sensor or push button), and the memory 1602.

The head-wearable apparatus 116 is connected to a host computer. For example, the head-wearable apparatus 116 is paired with the mobile device 114 via the high-speed wireless connection 1614 or connected to the server system 1604 via the network 1616. The server system 1604 may be one or more computing devices as part of a service or network computing system, for example, that includes a processor, a memory, and a network communication interface to communicate over the network 1616 with the mobile device 114 and the head-wearable apparatus 116.

The mobile device 114 includes a processor and a network communication interface coupled to the processor. The network communication interface allows for communication over the network 1616, low-power wireless connection 1612, or high-speed wireless connection 1614. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1620. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1604, such as the user input device 1628, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1612 and high-speed wireless connection 1614 from the mobile device 114 via the low-power wireless circuitry 1634 or high-speed wireless circuitry 1632.

### Machine Architecture

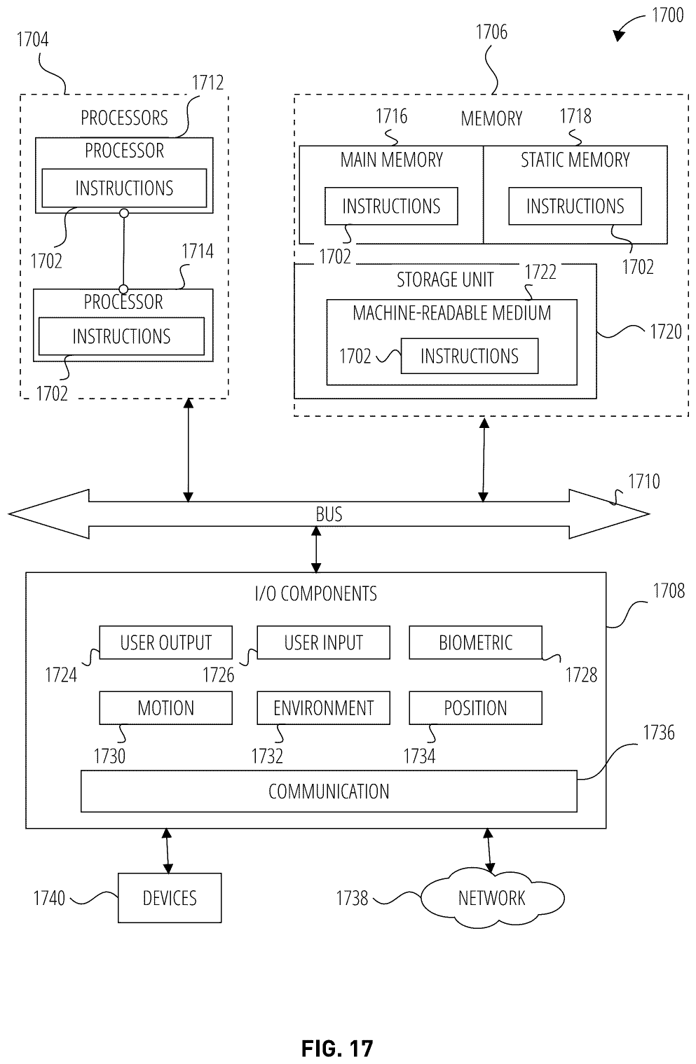

FIG. 17 is a diagrammatic representation of the machine 1700 within which instructions 1702 (e.g., software, a program, an application, an applet, an app, or other executable code) for causing the machine 1700 to perform any one or more of the methodologies discussed herein may be executed. For example, the instructions 1702 may cause the machine 1700 to execute any one or more of the methods described herein. The instructions 1702 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1702, sequentially or otherwise, that specify actions to be taken by the machine 1700. Further, while a single machine 1700 is illustrated, the term “machine” shall also be taken to include a collection of machines that individually or jointly execute the instructions 1702 to perform any one or more of the methodologies discussed herein. The machine 1700, for example, may comprise the user system 102 or any one of multiple server devices forming part of the interaction server system 110. In some examples, the machine 1700 may also comprise both client and server systems, with certain operations of a particular method or algorithm being performed on the server-side and with certain operations of the particular method or algorithm being performed on the client-side.

The machine 1700 may include processors 1704, memory 1706, and input/output I/O components 1708, which may be configured to communicate with each other via a bus 1710. In an example, the processors 1704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1712 and a processor 1714 that execute the instructions 1702. The term “processor” is intended to include multi-core processors that may comprise two or more independent processors (sometimes referred to as “cores”) that may execute instructions contemporaneously. Although FIG. 17 shows multiple processors 1704, the machine 1700 may include a single processor with a single-core, a single processor with multiple cores (e.g., a multi-core processor), multiple processors with a single core, multiple processors with multiples cores, or any combination thereof.

The memory 1706 includes a main memory 1716, a static memory 1718, and a storage unit 1720, both accessible to the processors 1704 via the bus 1710. The main memory 1706, the static memory 1718, and storage unit 1720 store the instructions 1702 embodying any one or more of the methodologies or functions described herein. The instructions 1702 may also reside, completely or partially, within the main memory 1716, within the static memory 1718, within machine-readable medium 1722 within the storage unit 1720, within at least one of the processors 1704 (e.g., within the processor's cache memory), or any suitable combination thereof, during execution thereof by the machine 1700.

The I/O components 1708 may include a wide variety of components to receive input, provide output, produce output, transmit information, exchange information, capture measurements, and so on. The specific I/O components 1708 that are included in a particular machine will depend on the type of machine. For example, portable machines such as mobile phones may include a touch input device or other such input mechanisms, while a headless server machine will likely not include such a touch input device. It will be appreciated that the I/O components 1708 may include many other components that are not shown in FIG. 17. In various examples, the I/O components 1708 may include user output components 1724 and user input components 1726. The user output components 1724 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The user input components 1726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1708 may include biometric components 1728, motion components 1730, environmental components 1732, or position components 1734, among a wide array of other components. For example, the biometric components 1728 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1730 include acceleration sensor components (e.g., accelerometer), gravitation sensor components, rotation sensor components (e.g., gyroscope).

The environmental components 1732 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1708 further include communication components 1736 operable to couple the machine 1700 to a network 1738 or devices 1740 via respective coupling or connections. For example, the communication components 1736 may include a network interface component or another suitable device to interface with the network 1738. In further examples, the communication components 1736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1740 may be another machine or any of a wide variety of peripheral devices (e.g., a peripheral device coupled via a USB).

Moreover, the communication components 1736 may detect identifiers or include components operable to detect identifiers. For example, the communication components 1736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1736, such as location via Internet Protocol (IP) geolocation, location via Wi-Fi® signal triangulation, location via detecting an NFC beacon signal that may indicate a particular location, and so forth.

The various memories (e.g., main memory 1716, static memory 1718, and memory of the processors 1704) and storage unit 1720 may store one or more sets of instructions and data structures (e.g., software) embodying or used by any one or more of the methodologies or functions described herein. These instructions (e.g., the instructions 1702), when executed by processors 1704, cause various operations to implement the disclosed examples.

The instructions 1702 may be transmitted or received over the network 1738, using a transmission medium, via a network interface device (e.g., a network interface component included in the communication components 1736) and using any one of several well-known transfer protocols (e.g., hypertext transfer protocol [HTTP]). Similarly, the instructions 1702 may be transmitted or received using a transmission medium via a coupling (e.g., a peer-to-peer coupling) to the devices 1740.

### Software Architecture

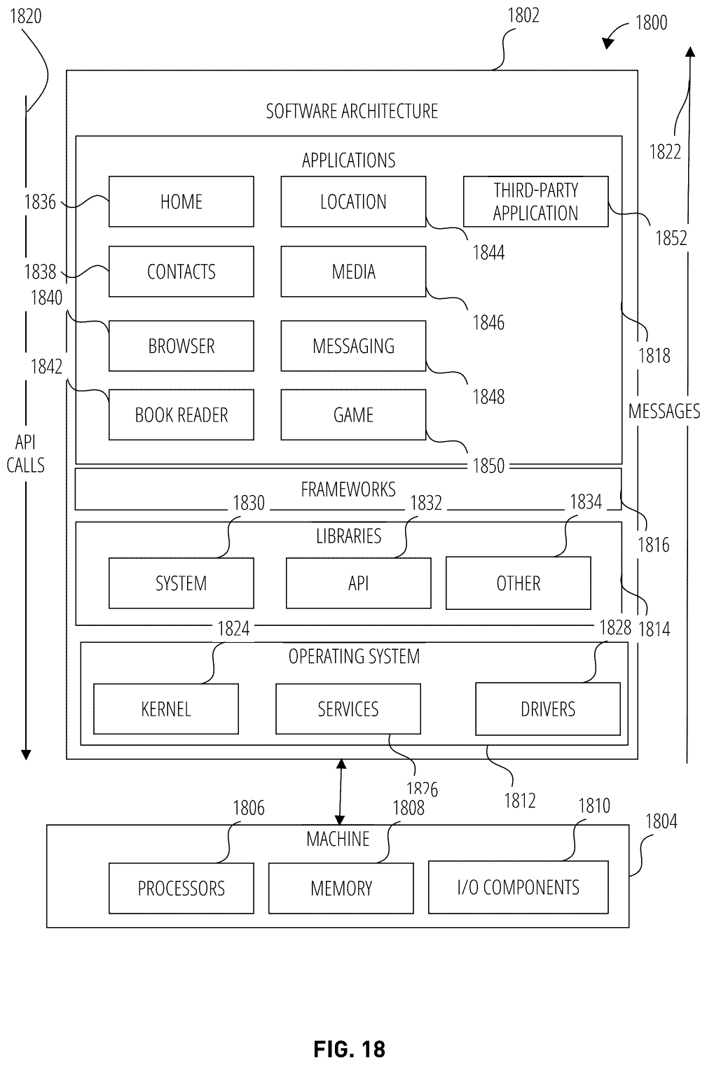

FIG. 18 is a block diagram 1800 illustrating a software architecture 1802, which can be installed on any one or more of the devices described herein. The software architecture 1802 is supported by hardware such as a machine 1804 that includes processors 1806, memory 1808, and I/O components 1810. In this example, the software architecture 1802 can be conceptualized as a stack of layers, where each layer provides a particular functionality. The software architecture 1802 includes layers such as an operating system 1812, libraries 1814, frameworks 1816, and applications 1818. Operationally, the applications 1818 invoke API calls 1820 through the software stack and receive messages 1822 in response to the API calls 1820.

The operating system 1812 manages hardware resources and provides common services. The operating system 1812 includes, for example, a kernel 1824, services 1826, and drivers 1828. The kernel 1824 acts as an abstraction layer between the hardware and the other software layers. For example, the kernel 1824 provides memory management, processor management (e.g., scheduling), component management, networking, and security settings, among other functionalities. The services 1826 can provide other common services for the other software layers. The drivers 1828 are responsible for controlling or interfacing with the underlying hardware. For instance, the drivers 1828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1814 provide a common low-level infrastructure used by the applications 1818. The libraries 1814 can include system libraries 1830 (e.g., C standard library) that provide functions such as memory allocation functions, string manipulation functions, mathematic functions, and the like. In addition, the libraries 1814 can include API libraries 1832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1814 can also include a wide variety of other libraries 1834 to provide many other APIs to the applications 1818.

The frameworks 1816 provide a common high-level infrastructure that is used by the applications 1818. For example, the frameworks 1816 provide various graphical user interface (GUI) functions, high-level resource management, and high-level location services. The frameworks 1816 can provide a broad spectrum of other APIs that can be used by the applications 1818, some of which may be specific to a particular operating system or platform.

In an example, the applications 1818 may include a home application 1836, a contacts application 1838, a browser application 1840, a book reader application 1842, a location application 1844, a media application 1846, a messaging application 1848, a game application 1850, and a broad assortment of other applications such as a third-party application 1852. The applications 1818 are programs that execute functions defined in the programs. Various programming languages can be employed to create one or more of the applications 1818, structured in a variety of manners, such as object-oriented programming languages (e.g., Objective-C, Java, or C++) or procedural programming languages (e.g., C or assembly language). In a specific example, the third-party application 1852 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1852 can invoke the API calls 1820 provided by the operating system 1812 to facilitate functionalities described herein.

### Machine-Learning Pipeline

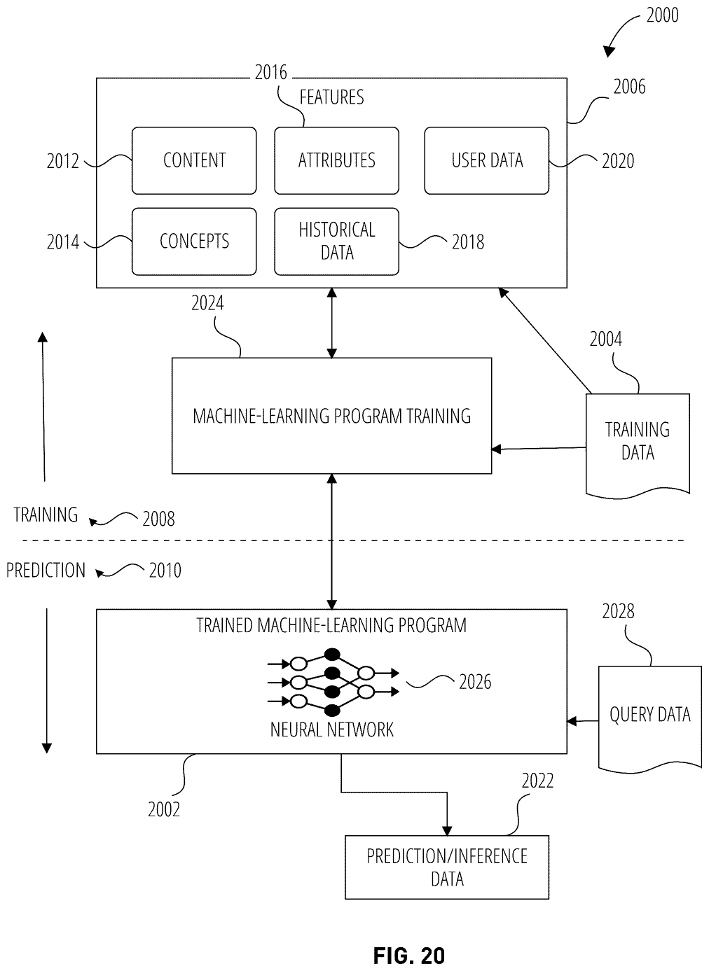

FIG. 20 is a flowchart depicting a machine-learning pipeline 2000, according to some examples. The machine-learning pipelines 2000 may be used to generate a trained model, for example the trained machine-learning program 2002 of FIG. 20, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
1. Supervised learning involves training a model using labeled data to predict an output for new, unseen inputs. Examples of supervised learning algorithms include linear regression, decision trees, and neural networks.
2. Unsupervised learning involves training a model on unlabeled data to find hidden patterns and relationships in the data. Examples of unsupervised learning algorithms include clustering, principal component analysis, and generative models like autoencoders.
3. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

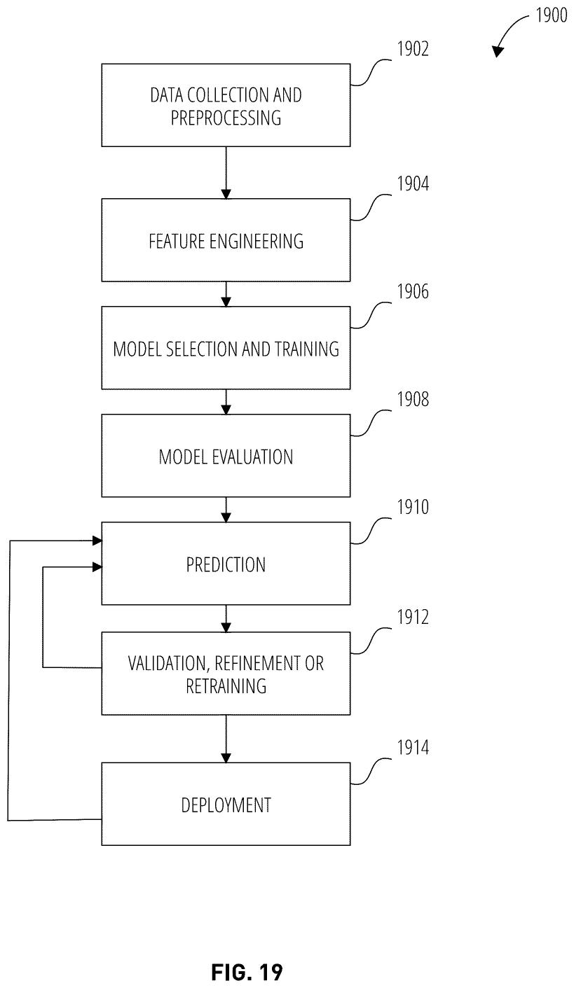

Generating a trained machine-learning program 2002 may include multiple types of phases that form part of the machine-learning pipeline 2000, including for example the following phases 1900 illustrated in FIG. 19:
1. Data collection and preprocessing 1902: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
2. Feature engineering 1904: This may include selecting and transforming the training data 2004 to create features that are useful for predicting the target variable. Feature engineering may include (1) receiving features 2006 (e.g., as structured or labeled data in supervised learning) and/or (2) identifying features 2006 (e.g., unstructured or unlabeled data for unsupervised learning) in training data 2004.
3. Model selection and training 1906: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
4. Model evaluation 1908: This may include evaluating the performance of a trained model (e.g., the trained machine-learning program 2002) on a separate testing dataset. This can help determine if the model is overfitting or underfitting and if it is suitable for deployment.
5. Prediction 1910: This involves using a trained model (e.g., trained machine-learning program 2002) to generate predictions on new, unseen data.
6. Validation, refinement or retraining 1912: This may include updating a model based on feedback generated from the prediction phase, such as new data or user feedback.
7. Deployment 1914: This may include integrating the trained model (e.g., the trained machine-learning program 2002) into a larger system or application, such as a web service, mobile app, or IoT device. This can involve setting up APIs, building a user interface, and ensuring that the model is scalable and can handle large volumes of data.

FIG. 20 illustrates two example phases, namely a training phase 2008 (part of the model selection and trainings phase 1906) and a prediction phase 2010 (part of prediction phase 1910). Prior to the training phase 2008, feature engineering 1904 is used to identify features 2006. This may include identifying informative, discriminating, and independent features for the effective operation of the trained machine-learning program 2002 in pattern recognition, classification, and regression. In some examples, the training data 2004 includes labeled data, which is known data for pre-identified features 2006 and one or more outcomes.

Each of the features 2006 may be a variable or attribute, such as individual measurable property of a process, article, system, or phenomenon represented by a data set (e.g., the training data 2004). Features 2006 may also be of different types, such as numeric features, strings, vectors, matrices, encodings, and graphs, and may include one or more of content 2012, concepts 2014, attributes 2016, historical data 2018 and/or user data 2020, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 2008, the machine-learning pipeline 2000 uses the training data 2004 to find correlations among the features 2006 that affect a predicted outcome or prediction/inference data 2022.

With the training data 2004 and the identified features 2006, the trained machine-learning program 2002 is trained during the training phase 2008 during machine-learning program training 2024. The machine-learning program training 2024 appraises values of the features 2006 as they correlate to the training data 2004. The result of the training is the trained machine-learning program 2002 (e.g., a trained or learned model).

Further, the training phase 2008 may involve machine learning, in which the training data 2004 is structured (e.g., labeled during preprocessing operations), and the trained machine-learning program 2002 implements a relatively simple neural network 2026 capable of performing, for example, classification and clustering operations. In other examples, the training phase 2008 may involve deep learning, in which the training data 2004 is unstructured, and the trained machine-learning program 2002 implements a deep neural network 2026 that is able to perform both feature extraction and classification/clustering operations.

A neural network 2026 may, in some examples, be generated during the training phase 2008, and implemented within the trained machine-learning program 2002. The neural network 2026 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 2026 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 2026 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 2008, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 2026 is iteratively trained by adjusting model parameters to minimize a specific loss function or maximize a certain objective. The system can continue to train the neural network 2026 by adjusting parameters based on the output of the validation, refinement, or the retraining phase 1912, and rerun the prediction phase 1910 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 2026 even after the deployment phase 1914 of the neural network 2026. The neural network 2026 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 2010, the trained machine-learning program 2002 uses the features 2006 for analyzing query data 2028 to generate inferences, outcomes, or predictions, as examples of a prediction/inference data 2022. For example, during prediction phase 2010, the trained machine-learning program 2002 is used to generate an output. Query data 2028 is provided as an input to the trained machine-learning program 2002, and the trained machine-learning program 2002 generates the prediction/inference data 2022 as output, responsive to receipt of the query data 2028. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 2002 may be a generative AI model. Generative AI is a term that may refer to any type of artificial intelligence that can create new content from training data 2004. For example, generative AI can produce text, images, video, audio, code or synthetic data that are similar to the original data but not identical.

Some of the techniques that may be used in generative AI are:
1. Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
2. Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
3. Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
4. Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
5. Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 2022 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a first prompt of a first user via a user interface of a user device indicating a user's intent; processing the first prompt using a first machine learning model to generate a second prompt that is applied to a second machine learning model, the second prompt indicative of attributes identified in the first prompt; capturing an image of the first user via a live camera feed of the user device; processing a combination of the image of the first user with the second prompt using the second machine learning model to generate a plurality of images; and applying the plurality of images to the live camera feed of the user device.

In Example 2, the subject matter of Example 1 includes, wherein the first prompt is received via the user interface that is displaying the live camera feed of the user device.

In Example 3, the subject matter of Examples 1-2 includes, wherein the operations further comprise: accessing historical interaction data of the first user with the system indicative of a first user's interaction with features provided to the first user by the system; identifying one or more preferences of the first user based on the accessed historical interaction data of the first user; and modifying the first prompt based on the identified one or more preferences of the first user, wherein processing the first prompt comprises processing the modified first prompt.

In Example 4, the subject matter of Example 3 includes, wherein identifying the one or more preferences comprises inputting the historical interaction data into a third machine learning model to generate an identity graph of the first user, the identity graph including the one or more preferences of the first user.

In Example 5, the subject matter of Examples 1-4 includes, wherein processing the combination of the image of the first user with the second prompt includes inputting the captured image into the second machine learning model.

In Example 6, the subject matter of Examples 1-5 includes, wherein processing the combination of the image of the first user with the second prompt includes identifying facial features of the first user via the image, and processing the facial features by the second machine learning model.

In Example 7, the subject matter of Examples 1-6 includes, wherein the operations further comprise: generating a plurality of second prompts by the second machine learning model, each of the plurality of second prompts indicative of a different scenario in response to the first prompt; and selecting the second prompt from the plurality of second prompts to be applied to the second machine learning model.

In Example 8, the subject matter of Example 7 includes, wherein the selecting of the second prompt is performed randomly.

In Example 9, the subject matter of Examples 7-8 includes, wherein the selecting of the second prompt is based on one or more preferences of the user, the one or more preferences of the user being identified by inputting historical interaction data into a third machine learning model to generate an identity graph of the first user, the identity graph including the one or more preferences of the first user, the historical interaction data of the first user with the system indicative of the first user's interaction with features provided to the first user by the system.

In Example 10, the subject matter of Examples 1-9 includes, wherein the operations further comprise: generating a plurality of second prompts by the second machine learning model, each of the plurality of second prompts indicative of a different scenario in response to the first prompt; processing each of the plurality of second prompts using the second machine learning model to generate corresponding images; and applying the each of the corresponding images to the live camera feed of the user device.

In Example 11, the subject matter of Examples 1-10 includes, wherein the second machine learning model includes a stable diffusion model that introduces noise iteratively to update pixel values in a generated image based on neighboring pixels.

In Example 12, the subject matter of Examples 1-11 includes, wherein applying the plurality of images to the live camera feed of the user device comprises overlaying one or more of the images onto the live camera feed such that the one or more of the images align with a user's head position and user movements.

In Example 13, the subject matter of Example 12 includes, wherein the operations further comprise: rotating the one or more images above the head of the user in the live camera feed.

In Example 14, the subject matter of Example 13 includes, wherein the operations further comprise reducing speed of rotation until a final selected image is presented above the user's head in the live camera feed.

In Example 15, the subject matter of Examples 1-14 includes, wherein the operations further comprise: identifying a second user in the live camera feed; capturing an image of the second user; and updating the images being applied to the live camera feed to reflect an identity of the second user.

In Example 16, the subject matter of Examples 1-15 includes, wherein the operations further comprise: processing the second prompt using a third machine learning model, the third machine learning model being an LLM and being trained to generate third prompts from second prompts, the third prompt including instructions for the generation of images responsive to the first prompt, wherein processing the combination of the image of the first user with the second prompt using the second machine learning model comprises processing the combination of the image of the first user with the instructions.

In Example 17, the subject matter of Examples 1-16 includes, wherein the operations further comprise: processing the second prompt using a third machine learning model, the third machine learning model being a diffusion model and being trained to generate images from second prompts, the generated images from the third machine learning model not maintaining an identity of the user, wherein the second machine learning model further processes the images that do not maintain the identity of the user to generate the plurality of images.

In Example 18, the subject matter of Examples 1-17 includes, wherein the operations further comprise: training the first machine learning model by: identifying training first prompts and corresponding training second prompts expected for the training first prompts; applying the training first prompts to the first machine learning model to receive output second prompts; compare the output second prompts with the expected second prompts to determine a loss parameter for the first machine learning model; and update a characteristic of the first machine learning model based on the loss parameter.

Example 19 is a method comprising: receiving a first prompt of a first user via a user interface of a user device indicating a user's intent; processing the first prompt using a first machine learning model to generate a second prompt that is applied to a second machine learning model, the second prompt indicative of attributes identified in the first prompt; capturing an image of the first user via a live camera feed of the user device; processing a combination of the image of the first user with the second prompt using the second machine learning model to generate a plurality of images; and applying the plurality of images to the live camera feed of the user device.

Example 20 is a non-transitory computer-readable storage medium storing instructions that, when executed by at least one processor, cause the at least one processor to perform operations comprising: receiving a first prompt of a first user via a user interface of a user device indicating a user's intent; processing the first prompt using a first machine learning model to generate a second prompt that is applied to a second machine learning model, the second prompt indicative of attributes identified in the first prompt; capturing an image of the first user via a live camera feed of the user device; processing a combination of the image of the first user with the second prompt using the second machine learning model to generate a plurality of images; and applying the plurality of images to the live camera feed of the user device.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### Conclusion

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a first prompt of a first user via a user interface of a user device indicating a user's intent;
processing the first prompt using a first machine learning model to generate a second prompt that is applied to a second machine learning model, the second prompt indicative of attributes identified in the first prompt;
capturing an image of the first user via a live camera feed of the user device;
processing a combination of the image of the first user with the second prompt using the second machine learning model to generate a plurality of images; and
applying the plurality of images to the live camera feed of the user device.

2. The system of claim 1, wherein the first prompt is received via the user interface that is displaying the live camera feed of the user device.

3. The system of claim 1, wherein the operations further comprise:
accessing historical interaction data of the first user with the system indicative of a first user's interaction with features provided to the first user by the system;
identifying one or more preferences of the first user based on the accessed historical interaction data of the first user; and
modifying the first prompt based on the identified one or more preferences of the first user, wherein processing the first prompt comprises processing the modified first prompt.

4. The system of claim 3, wherein identifying the one or more preferences comprises inputting the historical interaction data into a third machine learning model to generate an identity graph of the first user, the identity graph including the one or more preferences of the first user.

5. The system of claim 1, wherein processing the combination of the image of the first user with the second prompt includes inputting the captured image into the second machine learning model.

6. The system of claim 1, wherein processing the combination of the image of the first user with the second prompt includes identifying facial features of the first user via the image, and processing the facial features by the second machine learning model.

7. The system of claim 1, wherein the operations further comprise:
generating a plurality of second prompts by the second machine learning model, each of the plurality of second prompts indicative of a different scenario in response to the first prompt; and
selecting the second prompt from the plurality of second prompts to be applied to the second machine learning model.

8. The system of claim 7, wherein the selecting of the second prompt is performed randomly.

9. The system of claim 7, wherein the selecting of the second prompt is based on one or more preferences of the user, the one or more preferences of the user being identified by inputting historical interaction data into a third machine learning model to generate an identity graph of the first user, the identity graph including the one or more preferences of the first user, the historical interaction data of the first user with the system indicative of the first user's interaction with features provided to the first user by the system.

10. The system of claim 1, wherein the operations further comprise:
generating a plurality of second prompts by the second machine learning model, each of the plurality of second prompts indicative of a different scenario in response to the first prompt;
processing each of the plurality of second prompts using the second machine learning model to generate corresponding images; and
applying the each of the corresponding images to the live camera feed of the user device.

11. The system of claim 1, wherein the second machine learning model includes a stable diffusion model that introduces noise iteratively to update pixel values in a generated image based on neighboring pixels.

12. The system of claim 1, wherein applying the plurality of images to the live camera feed of the user device comprises overlaying one or more of the images onto the live camera feed such that the one or more of the images align with a user's head position and user movements.

13. The system of claim 12, wherein the operations further comprise: rotating the one or more images above the head of the user in the live camera feed.

14. The system of claim 13, wherein the operations further comprise reducing speed of rotation until a final selected image is presented above the user's head in the live camera feed.

15. The system of claim 1, wherein the operations further comprise:
identifying a second user in the live camera feed;
capturing an image of the second user; and
updating the images being applied to the live camera feed to reflect an identity of the second user.

16. The system of claim 1, wherein the operations further comprise: processing the second prompt using a third machine learning model, the third machine learning model being an LLM and being trained to generate third prompts from second prompts, the third prompt including instructions for the generation of images responsive to the first prompt, wherein processing the combination of the image of the first user with the second prompt using the second machine learning model comprises processing the combination of the image of the first user with the instructions.

17. The system of claim 1, wherein the operations further comprise:
processing the second prompt using a third machine learning model, the third machine learning model being a diffusion model and being trained to generate images from second prompts, the generated images from the third machine learning model not maintaining an identity of the user, wherein the second machine learning model further processes the images that do not maintain the identity of the user to generate the plurality of images.

18. The system of claim 1, wherein the operations further comprise:
training the first machine learning model by:
identifying training first prompts and corresponding training second prompts expected for the training first prompts;
applying the training first prompts to the first machine learning model to receive output second prompts;
compare the output second prompts with the expected second prompts to determine a loss parameter for the first machine learning model; and
update a characteristic of the first machine learning model based on the loss parameter.

19. A method comprising:
receiving a first prompt of a first user via a user interface of a user device indicating a user's intent;
processing the first prompt using a first machine learning model to generate a second prompt that is applied to a second machine learning model, the second prompt indicative of attributes identified in the first prompt;
capturing an image of the first user via a live camera feed of the user device;
processing a combination of the image of the first user with the second prompt using the second machine learning model to generate a plurality of images; and
applying the plurality of images to the live camera feed of the user device.

20. A non-transitory computer-readable storage medium storing instructions that, when executed by at least one processor, cause the at least one processor to perform operations comprising:
receiving a first prompt of a first user via a user interface of a user device indicating a user's intent;
processing the first prompt using a first machine learning model to generate a second prompt that is applied to a second machine learning model, the second prompt indicative of attributes identified in the first prompt;
capturing an image of the first user via a live camera feed of the user device;
processing a combination of the image of the first user with the second prompt using the second machine learning model to generate a plurality of images; and
applying the plurality of images to the live camera feed of the user device.
